(19) United States
(12) Patent Application Publication
(10) Pub. No.: US 2007/0022644 A1
(43) Pub. Date: Feb. 1, 2007

(54) Merchandise display systems

(76) Inventors: Peter Fyler Lynch, Skaneateles, NY (US); Gary Curtis Joseph, Mason, OH (US); Peter Scott Maciulewicz, Auburn, NY (US); Thomas Brian Norris, Milford, OH (US); William Paul Mahoney III, Liberty Township, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/496,911

(22) Filed: Aug. 1, 2006

Related U.S. Application Data
(60) Provisional application No. 60/704,410, filed on Aug. 1, 2005.

(51) Int. Cl. G09F 9/37

(52) U.S. Cl. 40/446; 211/57.1

(57) ABSTRACT

Merchandise display systems and methods of displaying merchandise are disclosed. The merchandise display systems may draw consumers' attention to products with reduced impact on the space available to display the product. The merchandise display systems may illuminate products and/or portions thereof, evenly, or without casting shadows. The merchandise display systems may be attached to retail displays.

### CROSS REFERENCE TO RELATED APPLICATIONS

This application claims the benefit of U.S. Provisional Application No. 60/704,410, filed Aug. 1, 2005.

### FIELD OF THE INVENTION

Merchandise display systems.

### BACKGROUND OF THE INVENTION

The commercial success of a product may be dependent, at least in part, upon the manner in which it is displayed at the point of purchase. This is particularly true with respect to new products that are placed on a crowded store shelf for the first time. A consumer may be unaware of a product and may miss it among the sea of other products on display. Consequently, manufacturers, wholesalers, retailers and advertisers are continually searching for new merchandise display systems that will draw a consumer's attention to a particular product.

Conventional point of purchase display devices often utilize lighting devices, graphic designs, three dimensional cutouts, fluorescent paint and the like, in order to draw the consumer's eye to a particular product in an environment that is already saturated with products. These eye-catching devices can be costly, and may require substantial modification of store shelves. Additionally, the devices may result in further crowding of an already overcrowded environment, leaving less space on the shelves for the actual products that they highlight. This latter problem is especially of relevance given that many stores limit the amount of display space allocated to certain products; these limitations have resulted in competition among manufacturers and distributors over mere inches and centimeters of display space.

Lighting techniques have been used to emphasize and distinguish certain products over others at the point of purchase. However, known lighting techniques may have drawbacks including, but not limited to: taking up merchandise display space; unevenly lighting or casting shadows on the merchandise; heating the merchandise; requiring excessive electrical power; and requiring retrofitting of the display space with wiring to an existing power line.

Accordingly, there is a need for merchandise display systems that may draw a consumer's attention, while taking up minimal, if any, display space. Additionally, there is a need for merchandise displays, merchandise display systems, and other point of purchase display systems that efficiently and evenly light displayed product(s), and/or portions of product(s) without generating relatively high amounts of heat.

Further, there is a need for merchandise displays, merchandise display systems, and other point of purchase display systems that can be implemented to work with retail displays, including: shelving; gondola shelving; countertops; and the like.

In addition, it is desirable to provide a merchandise display system that may be triggered by a consumer. It is also desirable to provide a merchandise display system that may provide a consumer specific display.

### SUMMARY OF THE INVENTION

Merchandise display systems according to the present invention may draw a consumer's attention to merchandise in a retail environment via illumination of the merchandise using an electroluminescent panel. As compared to conventional powered lighting systems, the present merchandise display systems may illuminate merchandise with reduced impact on the space available for retail display, and the ambient temperature of the display environment. In some embodiments, the merchandise display systems illuminate products evenly, or without casting shadows. In some embodiments, the merchandise display systems are implemented to work without requiring excessive electrical power, and can even be implemented to work using a portable power source, thereby eliminating the necessity of retrofitting the retail display with wiring to an existing power line.

In some embodiments, the present invention relates to merchandise display systems, which comprise: merchandise; a surface; and an electroluminescent panel. The electroluminescent panel in turn comprises at least a first portion, which is disposed between the surface and the merchandise. When powered, at least the first portion of the electroluminescent panel illuminates the merchandise. In some embodiments, intensity of the illumination may change so that the merchandise display is more dramatic. In some embodiments, the electroluminescent panel may additionally, or in the alternative, cycle on and off.

In some embodiments, the merchandise display systems are in proximity to a retail display. Non-limiting examples of retail displays include: shelves; gondola shelving; countertops; pegboards; doors (such as a refrigerator or freezer door); and combinations thereof. In these embodiments, the merchandise display system comprises: merchandise; a surface oriented to support the merchandise; and an electroluminescent panel attached to the surface. When the electroluminescent panel is powered, the merchandise may be illuminated.

In some embodiments, the present invention relates to merchandise display systems, which comprise merchandise and an electroluminescent panel. The merchandise comprises packaging, which can comprise any one of multiple layers (e.g. a primary package, a secondary package, a tertiary package, etc.), some of which may be transparent. The electroluminescent panel is connected to at least one portion of the merchandise and is illuminated when powered. In some embodiments, the electroluminescent panel is shaped like indicia (such as brand names), and/or indicia may be printed on the light emitting panel.

In some embodiments, the present invention relates to methods for displaying merchandise in a retail environment. The methods may comprise the steps of: providing merchandise; providing a surface oriented to support the merchandise; providing an electroluminescent panel comprising at least a first portion, which is disposed in relation to the surface, such that the first portion is between the surface and the merchandise when the merchandise is displayed; and activating the electroluminescent panel.

These and other embodiments, aspects, and advantages are encompassed within the present invention, and will become better understood with regard to the following description and appended claims.

### BRIEF DESCRIPTION OF THE DRAWINGS

The accompanying figures show non-limiting example embodiments of merchandise display systems incorporating various aspects of the present invention:

FIG. 1 depicts the structure of an electroluminescent panel.

FIG. 2 through FIG. 5 are views of merchandise display systems, in which the surfaces are part of a system of shelves or gondolas in a retail outlet.

FIG. 6 is a view of a merchandise display system in which the surfaces are part of a system of shelves or gondolas in a retail outlet, which further comprises a stepped support.

FIG. 7 is a view of a merchandise display system, in which the surface is a peg board.

FIG. 8 is a view of a merchandise display system in which an additional portion of the electroluminescent panel covers the edge of the surface.

FIG. 9 depicts how the angular relation between a first portion and an additional portion of an electroluminescent panel may be measured.

FIG. 10 is a view of a merchandise display system wherein the surface is part of a system of shelves or gondolas in a retail outlet in which merchandise is illuminated.

FIG. 11 is a view of how the elements that make up a merchandise display system may be operatively connected.

FIG. 12 is a view of a merchandise display system attached to a retail display.

FIG. 13 is a view of a merchandise display system attached to a retail display.

FIG. 14 is a view of a merchandise display system in which elements of the system are operatively connected through the surface.

FIG. 15 is a view of a merchandise display system comprising an electroluminescent package connected directly to merchandise.

FIG. 16 is a view of a merchandise display system comprising an electroluminescent package connected directly to merchandise.

### DETAILED DESCRIPTION

“Illuminates”, as used herein, refers to the act of exposing merchandise to the energy of electromagnetic waves. Electromagnetic waves may be selected from the group consisting of: radio waves; microwaves; infrared waves; visible waves (i.e., light); ultraviolet waves; x-rays; gamma rays; and combinations thereof. The electromagnetic waves may be visible or invisible to the naked eye. If the electromagnetic waves are invisible to the naked eye, various means may be used to make the radiation visible to the consumer. For example, special glasses may be provided to the consumer so that he or she may see ultraviolet waves.

“Indicia”, as used herein, refers to any marking. Examples of markings include, but are not limited to: brand names, logos, trade marks, letters, words, phrases, pictures, symbols, figures, designs, patterns and combinations thereof.

“Comprising” as used herein may refer to the various components or steps that may be conjointly employed in practicing the present disclosure, although additional steps or components may be utilized if desired. Accordingly, the term “comprising” may encompass the more restrictive terms “consisting essentially of” and “consisting of”.

The merchandise display systems of the present invention may comprise elements selected from the group consisting of: A merchandise; B a surface; C an electromagnetic radiation emitting panel including, but not limited to, an electroluminescent panel; D a triggering device; E an activator; F miscellaneous elements; and combinations thereof. The elements are described in further detail below.

A. Merchandise

The merchandise to be displayed in the merchandise display systems of the present invention can comprise any product, or a plurality of products, on display in a retail environment. “Product” as used herein refers to any article of manufacture, and non-limiting examples thereof include: items; devices; and appliances. Non-limiting uses of products include for: personal care, baby care, beauty care, health care, animal/pet care, household use; automotive use; and combinations thereof. For the purposes of the present invention, products removed from the retail environment may not be considered merchandise.

In some embodiments, the merchandise display systems comprise products that are not identical to that which is offered for sale. Rather, alternative embodiments may be used to demonstrate: the efficacy of a product; how the product works; how the product is different from its competitors; and combinations thereof.

Products may comprise packaging. Packaging can comprise any form and may be any one or more of multiple layers. For instance, a product may be contained within a primary package and the primary package may in turn be contained within a secondary package, and so on. For example, Olay™ Total Effects Cream™, which is sold by the Procter & Gamble Company (Cincinnati, Ohio), is contained within a primary package comprising a jar, which is in turn enclosed in secondary package comprising a cardboard box. Multiple units of Olay™ Total Effects Cream™ may be packaged in a tertiary package comprising a carton.

The various layers of packaging may be designed such that when the product is displayed in the merchandise display systems of the present invention, the following may be illuminated: at least one portion of the product; the interior of the package(s); the exterior of the package(s); and combinations thereof. Some embodiments comprise a product and/or package with transparent portions.

Merchandise may be specifically designed to capture, amplify, and re-direct the light that is transmitted from the light emitting panel. In one embodiment, packaging may be made with interior surfaces placed in angular relations to the incident light from the light emitting panel such that the light is re-directed within the package. In some embodiments, the product and/or packaging may be at least in part photochromic, phosphorescent, fluorescent and combinations thereof. In yet another embodiment, the product and/or packaging may be photosensitive, such that the respective physical properties are changed when exposed to the light from the light emitting panel.

B. Surface

Merchandise display systems incorporating aspects of the present invention comprise a surface or plurality of surfaces oriented to support the merchandise. The surface can be any surface that is suitable for displaying merchandise. Non-limiting examples of surfaces are selected from the group consisting of: shelves; gondola shelving; countertops; floors; walls; ceilings; pegboards; and combinations thereof. The surface may be oriented in a number of ways to support merchandise. For example, in one embodiment, the merchandise may hang via a support that is hooked to a surface, such as a pegboard. In another embodiment, the merchandise may sit on a stepped support that is placed upon a shelf or countertop. Various means of support are shown in the Examples section infra.

In some embodiments of the present invention, an electromagnetic radiation emitting panel may simply sit on top of the surface, or it may be secured thereto via methods known in the art, including, but not limited to the use of: adhesives; Velcro™; tacks; nails; hooks; fasteners; clamps; tapes and combinations thereof. In other embodiments, the light emitting panel may even form a part of the surface. For example, a shelf could be constructed from an electroluminescent panel, or a laminate comprising an electroluminescent panel, or the shelf and an electroluminescent panel may otherwise be integrated. The shelving may comprise a translucent or transparent material in some embodiments. In those embodiments in which the light emitting panel is an electroluminescent panel, at least a first portion of the electroluminescent panel may be disposed between the surface and the merchandise.

In further embodiments, the electromagnetic radiation emitting panel may be secured to a surface that is placed in proximity to existing displays in a retail environment.

C. Electromagnetic Radiation Emitting Panel

The merchandise display systems of the present invention comprise an electromagnetic radiation emitting panel. A non-limiting example of an electromagnetic radiation emitting panel is a light emitting panel. Light emitting panels of use may be selected from any number of suitable panels, and may for example be flat, thin, and/or solid-state. Non-limiting examples of light emitting panels include: flat plasma; LCD display panels; LED display panels; flat televisions; bioluminescent panels; electroluminescent panels; and the like. In the various embodiments of the present invention, one type of light emitting panel may be used, or combinations of more than one type of panel may be used.

The physical dimensions of light emitting panels may vary according to the type and quantity of merchandise to be displayed, as well as the surface to be used to support the merchandise. In some embodiments, it may be important to reduce the amount of shelf space taken up by the panels. As such, the light emitting panels of use in the present invention may be less than about 0.5 inches thick, less than about 0.25 inches thick, less than about 0.125 inches thick, or less than 0.0625 inches thick. In addition, or in the alternative, the light emitting panels may be a part of a merchandise display system attached to a retail display, such as is shown in the Examples section infra.

Electroluminescent (EL) panels are one type of light emitting panel that is of use in the merchandise display systems of the present invention. Suitable EL panels for use in the merchandise display systems are obtainable from various manufacturers, including: Cochief Industrial Company, Shinjuang, Tapai, and Helpdezk, Chai Wan, Hong Kong, both of which are located in the Republic of China. Suppliers of EL panels of use include: Novatech, Chino, Calif.; E-Lite Technologies Inc., Trumbull, Conn.; and Ceelite, Lansdale, Pa.; Being Seen Technologies, Bridgewater, Mass.; all of which are located in the United States.

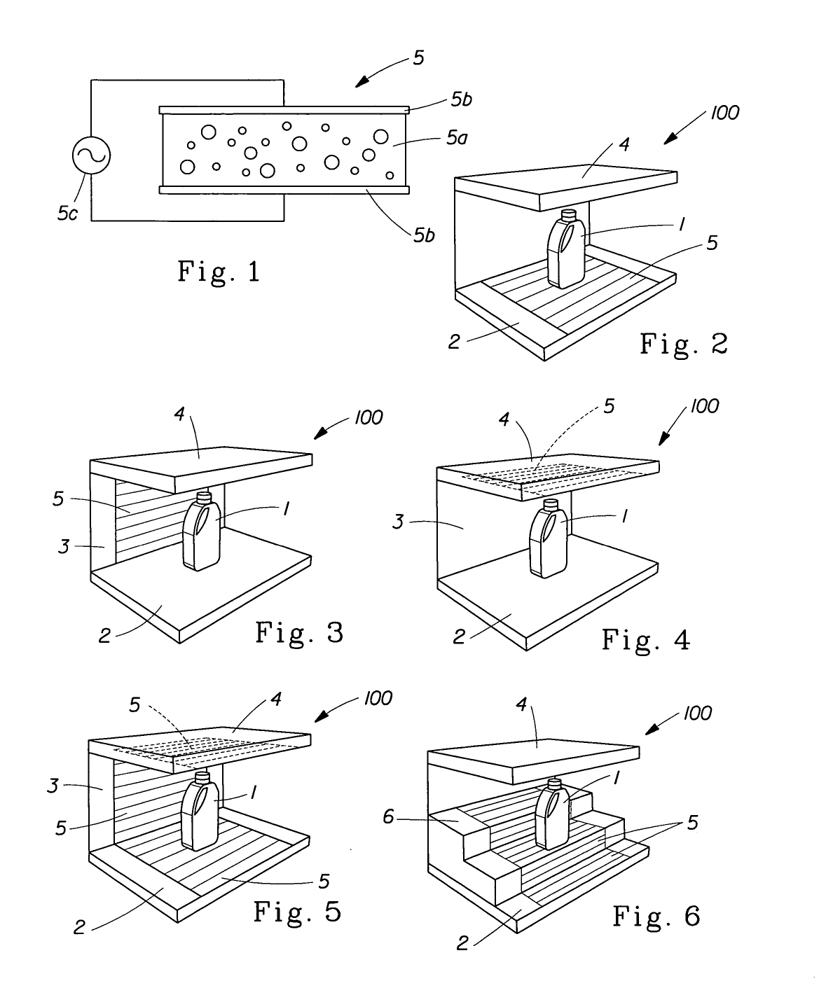

FIG. 1 shows one possible structure of an EL panel 5. The panel 5 comprises a light emitting layer 5a sandwiched between two electrodes 5b, which include transparent front, and rear film electrodes. The light emitting layer 5a, which may comprise phosphor, is the light emitting portion of the EL panel 5 and the transparent electrodes 5b are the light transmitting portions of the EL panel. The EL panel 5 may be powered when voltage is applied across the electrodes via a power circuit 5c. When the EL panel 5 is powered, light may be generated from the emitting layer 5a, which may be radiated through the transparent electrodes 5b. For example, in one embodiment, a thin layer of electroluminescent material is provided between two transparent electrodes which function as a capacitor, and at least one of the electrodes is adjacent to a support surface of a retail shelving system. Each electrode is a layer of conducting material and is so thin that light is able to pass through the electrode and be transmitted to the surroundings. Contacts are provided to connect the electrodes to an AC power signal. When a voltage is applied from a power source, build-up of charge on the two surfaces effectively produces an increasing electric field that causes the light emitting phosphors within the electroluminescent material to emit light. The increasing voltage in one direction increases the field and this causes current to flow. The voltage decreases and rises in the opposite direction which also causes current to flow. Because of the flowing current, the electroluminescent layer emits light. Various other configurations are also possible, such as the use of electroluminescent wire or cable comprising inner and outer wires and a middle layer of light emitting phosphors. Moreover, one or more transparent or translucent protective or filtering layers may be provided on the outside of such devices, and the layers may be provided on a substrate layer. In other embodiments, other light emitting material may be utilized in addition to or as an alternative to electroluminescent material, in order to produce a substantially thin, flat, solid-state, illuminating panel that provides a large illuminating surface area.

EL panels may not generate heat under normal operating conditions. The amount of power needed to activate an EL panel may vary with the size of the panel. In one embodiment, a portable voltage source comprising a 12 volt battery pack consisting of eight 1.5 volt AA Cell batteries, powers an EL system containing one 2.75 by 5 inch EL panel for fourteen hours forty minutes.

The EL panels of use in the present invention may be of any suitable size and thickness for the present purposes. Generally, the thickness of an EL panel is determined by its surface area; larger EL panels are typically thicker than smaller ones. EL panels may have a thickness from about 0.008 inches to about 0.8 inches; from about 0.01 inches to about 0.1 inches; and from about 0.032 inches to about 0.062 inches. Thus when placed on a surface such as a shelf, an EL panel may take up very little of the space that would otherwise be allotted for display of merchandise. However, because the EL panel provides sources of light across a large surface area, efficient and effective illumination of the merchandise can be obtained.

When powered, an EL panel may evenly illuminate an area regardless of its size. To provide similar lighting effects using point sources of light, such as a light-emitting diode or an incandescent source, the requisite light diffuser may be mechanically complex and costly, and may not provide an evenly spread glow without illumination hot spots. Additionally, illuminating an irregularly shaped area or a curvilinear surface using a point source of light is also difficult. In contrast, light from an EL panel may be evenly distributed across the panel and the EL panel may be made to conform to the shape of the area to be illuminated. The light emitted by a powered EL panel may be soft and non-glaring. Powered EL panels may be highly visible in darkness, smoke, fog, etc., as compared to point-sources of light.

EL panels are generally flexible, and may be: cut; flexed; bent; and combinations thereof to conform to the shape of a surface and wrapped around its edges. Thus EL panels may be generally flat, curvilinear and combinations thereof. In general, EL panels maintain their ability to be powered when they are bent.

Multiple EL panels may be placed side by side, stacked and otherwise arrayed. The EL panels of the present invention may comprise a single, large panel, or multiple single panels may be placed together to create a larger panel. In some embodiments of the present invention, the EL panel comprises a first portion and at least one additional portion disposed in an angular relation to the first portion. In some embodiments, multiple EL panels may be arrayed such that a first portion comprises one panel; a second portion comprises another panel disposed in an angular relation to the first portion, and so on. The angular relation relative to the first portion may be selected from the group consisting of: a zero angle; an acute angle; a right angle; an obtuse angle, a straight angle; a reflex angle; a full angle and combinations thereof. For example, the one portion may be disposed relative to the another portion in an angle from about 25 to about 180 degrees, from about 45 to about 135 degrees or from about 60 to about 105 degrees. In one embodiment, the various portions comprising the EL panel may have different colors, hues, light intensities, indicia and combinations thereof. Additionally, or in the alternative, the various portions may be lit in different time intervals. Such intervals may create the illusion of movement for example.

Indicia may be applied to the EL panel using various methods known in the art, including, but not limited to: printing; painting; stamping; drawing; silk-screening; and combinations thereof, directly onto the transparent front film electrode of the panel. In addition, or in the alternative, a decorative cover sheet with cut-outs may be applied to the transparent front film electrode, such that light from the EL panel may shine through the cut out areas.

EL panels may comprise various shapes. EL panels may comprise shapes that are associated with brands. In one embodiment of the present invention, the EL panels take the shape of trademarked name such as Olay™, or Tide™, both of which are manufactured by the Procter & Gamble Company of Cincinnati, Ohio, USA. The panels may then be applied to the products themselves for use as a merchandise display system according to the present invention. In some embodiments, the EL panel may be in a shape that matches one of the features of a package.

Any suitable power systems may be of use in the present invention to power the light emitting panel and include, but are not limited to: portable voltage sources; line voltage; and combinations thereof. Portable voltage sources may be of any suitable type and in some embodiments may comprise batteries, and/or solar panels for example.

The power source may be wired directly to the light emitting panel and/or to any other element(s) operatively connected thereto. In addition, or in the alternative, the power source may be wired in line with the light emitting panel and the other element(s). In one embodiment, wiring may be run from the back of a light emitting panel, down the back of a series of shelves, to a battery which may be hidden in the base deck (the bottom of the bottommost shelf). Channels or conduits may be provided on or in the shelving, and the wiring may be run within these channels.

Some embodiments of the merchandise display system may utilize power inversion systems in order to provide the light emitting panel, and any element(s) operatively connected thereto, with the proper amount and type of current. Any suitable power inversion system is of use. Non-limiting examples of power inversion systems include: direct current (DC) to alternating current (AC) inverters; AC to AC inverters; and AC to DC inverters.

In some embodiments of the present invention, suitable inverters include: the “resonance” type, in which an alternating current is generated and amplified by means of an oscillation circuit using a transformer; and the “chopper” type, which generates AC by means of switching operation of high voltage direct current. When using resonance type inverters, the output voltage and frequency are determined by the power supply input voltage and the area of the electromagnetic radiation emitting panel being driven. Since the output waveform is sinusoidal, electromagnetic interference and radio frequency interference may be negligible. Since this type of inverter has a constant current characteristic, it automatically compensates for the natural decay that may be caused by aging in light emitting panels such as electroluminescent panels. In comparison, when using chopper type inverters, the changes in the voltage and frequency due to differences in the lit area are small. Chopper inverters can be lightweight, compact, and very efficient.

In one embodiment of the present invention, the light emitting mechanism of EL panels may utilize alternating polarity of the driving electrical field for efficient light generation. Thus, an EL panel may be driven via an alternating current (AC) drive method. However, DC may be of use, such as when it is effectively converted to AC by an inverter. The DC input to the inverter may be from about 3 to about 30 volts, and the inverter's output may be from about 30 to about 240 volts with a frequency of about 300 to about 4000 Hz, for example. Other oscillator or driver circuitry may be utilized as appropriate. For example, for battery operation of a merchandise display system comprising a light emitting panel, a DC to AC voltage/frequency inverter may be needed depending upon the desired lighting effect.

For line voltage (e.g., 115V, 60 Hz) operation of an EL panel, an AC to AC voltage/frequency inverter may be required. However, EL panels may be operated directly from line voltage when low brightness is desired. Regardless, the EL panel may be wired into a retail outlet's line. For example, if a store already has electrical power lines in its shelving sections, the inverter may be directly linked to that line.

One of skill in the art may base his or her choice of what type of current to use as well as whether and what type of inverter to use depending upon what type of light emitting panel is to be used. If the light emitting panel is an EL panel for example, then varying the panel voltage or frequency may change the panel brightness and to some extent the color. For example, increasing the voltage may increase EL panel brightness, whereas increasing the frequency may increase panel brightness and shift the color slightly. Thus, selecting the optimum voltage and frequency may depend upon the desired brightness, color and panel life.

D. Triggering Devices

In some embodiments, the electromagnetic radiation emitting panels may be operatively connected to a “triggering device”, which as used herein means a device that signals the panel and/or elements connected thereto to perform an action. Triggering devices of use in the present invention may comprise sensors that detect a change in the environment. A detected change in the environment may prompt the triggering device to send the signal.

One of skill in the art may choose a suitable triggering device based upon the environmental change(s) to be detected, and/or the desired means of signaling the light emitting panel and/or element(s) connected thereto. Triggering devices of use in the present invention may comprise sensors that detect a change in the environment. Non-limiting examples of changes in the environment include changes in: light; shape; images; audio level; infrared emissions; electric field; particle radiation; motion; sound; vibration; heat; cold; mass; location; smoke; pressure; and combinations thereof. Non-limiting examples of sensors include: acoustic sensors; motion sensors; infra-red sensors; proximity sensors; light sensors and combinations thereof. Non-limiting examples of means of sending a signal may include: sending an electronic signal; activating a switch; sending power; sending digital output; sending analog output; and combinations thereof. Transmission of signals may be via a physical connection such as wiring and/or can be remote, such as wireless.

Triggering devices of use in the present invention may be “passive” or “active”. Active triggering devices may listen for environmental changes intermittently, continuously and combinations thereof. Passive triggering devices may be signaled by the environmental change to power up. A non-limiting example of passive triggering device includes a Radio frequency identification (RFID) tag joined to the EL system through the appropriate circuitry.

Triggering devices may signal one or more electromagnetic radiation emitting panels and/or other elements operatively connected thereto to perform any action that is desired alone or in collection with other actions, for example to draw a consumer's attention to an object. In some embodiments, the radiation emitting panels may be signaled to turn on or off. In some embodiments, the radiation emitting panels may be signaled to change their actions. Non-limiting examples of changes in action include: emitting one or multiple wavelengths of electromagnetic radiation, such as light and radio waves; changing colors; blinking; turning on or changing a displayed image; changing intensity of the radiation emission; directing the emission in different directions; and combinations thereof.

In some embodiments, the change in the environment may be detected by the triggering device and the signal it sends may be chosen such that the merchandise display system provides a consumer-specific display. For example, in one embodiment the electromagnetic radiation emitting panel may provide one display for an adult and another for a child. In another embodiment, the panel may provide different displays to females and males. In yet another embodiment, the display may provide different displays based upon the consumer's native language. In further embodiments, different displays may be based upon pre-selected shopping profiles and the like. Further non-limiting embodiments are provided in the Examples section infra.

E. Activator

In some embodiments of the present invention, merchandise display systems may comprise an “activator”. “Activators” as used herein create a change in environment that may be sensed by a triggering device. One of skill in the art may choose any activator that creates a change in the environment that can be sensed by a triggering device. Non-limiting examples of changes in the environment include: sending of a signal, such as via electromagnetic radiation; changing an electric and/or magnetic field; casting light and/or shadows; sending mechanical waves through a medium, for example through air (sound); and combinations thereof. In some embodiments, the activator may be a person speaking, moving, pressing a button, or performing some other action. In other embodiments, the activator may be a device; non-limiting examples of such devices include: cell phones, powered RFID tags, portable broadcasting RF source or portable broadcasting infrared source and the like. In some embodiments, the devices may be attached to a shopping cart or shopping basket.

In some embodiments, the activators may have a button which allows the consumer to choose to interact with a merchandise display system. In other embodiments, an activator may be programmed to cause a change in the environment at intervals. Further embodiments of activators are described in the Examples section infra.

F. Miscellaneous Elements

In some embodiments of the present invention, the merchandise display systems may comprise control systems. Control systems may be used to integrate the activities of the electromagnetic radiation emitting panel(s) and/or other elements. Any suitable control system may be of use. One non-limiting example of a control system is the MSP430 micro controller manufactured by Texas Instruments, Dallas, Tex., USA. The MSP430 comprises software, an analog to digital converter and the memory software controls the behavior and characteristics of the overall merchandise display system. Non-limiting examples of other control systems include: sequential logic circuits; application specific integrated circuits or personal computers; personal digital assistants (PDA); programmable logic controllers (PLC); and combinations thereof.

In some embodiments of the present invention, the merchandise display system may comprise a memory system. Memory systems may be programmed to store various types of information. For example, the memory system may count the number of times that the merchandise display system is switched on and off by a triggering device. Any suitable memory system may be of use. Non-limiting examples of memory systems include: flash memory and eprom (erasable programmable read-only memory).

In some embodiments of the present invention, the merchandise display systems may comprise a safety system. The safety system may turn off a merchandise display system when a problem within the system is detected.

In one embodiment, the safety system comprises a feedback loop for operation monitoring and transient voltage suppressors to limit the possible output of the power inversion system. The feedback loop monitors the amount of current in the output circuit. Various amounts of current produce different voltages from the safety circuit which is fed into an analog to digital converter in the micro-controller; this gives a quantitative value to the status of the output circuit. Any change in status and the microcontroller will respond accordingly. The transient voltage suppressors will limit the output voltage of the power inverter when a fault condition occurs. The micro-controller reads the values coming from the safety system and determines from the values whether the merchandise display system should remain on or be turned off. In some embodiments of the present invention, the micro-controller also controls other functions that are independent of the safety system such as sensor monitoring and the tracking of time.

### EXAMPLES

The elements of the merchandise display system may be arranged in a variety of configurations, including, but not limited to those illustrated in the accompanying figures.

FIG. 2 is a perspective view of a series of shelves. The figure shows one embodiment of a merchandise display system 100 in which a product 1 is supported by a surface that is a retail shelf 2, wherein the shelf is partially covered by an EL panel 5 that rests on the retail shelf 2. An upper surface 4 (with respect to object 1) may be a shelf as well. From the perspective of the consumer (at the front of the shelf 2), the EL panel 5, when powered, will illuminate the product from below. The relatively low thickness of the EL panel 5 together with the relatively low heat output permits this method of shelf display to be utilized to effectively draw a retail consumer's attention to the product 1.

FIG. 3 shows another embodiment of a merchandise display system 100 according to the present invention. FIG. 3 is a perspective view of a retail shelf similar to that shown in FIG. 2. However, in the embodiment shown in FIG. 3, the EL panel 5 is disposed on a surface that is a shelf support, such as a back wall 3 to which shelves 4 can be attached. From the perspective of the consumer looking at merchandise on a store shelf, the EL panel 5, when powered, will illuminate the product 1 from the behind.

FIG. 4 shows another embodiment of a merchandise display system 100 according to the present invention. FIG. 4 is a perspective view of a series of surfaces 2, 3, 4, such as retail store shelves. As shown, a product 1 is supported by a surface 2. An EL panel 5 covers at least a portion of the underside of the surface 4 immediately above the merchandise, which surface can be an upper shelf, such that when the EL panel is powered, the merchandise appears illuminated from above when viewed by the consumer.

FIG. 5 shows an embodiment of a merchandise display system 100 that includes a product 1 supported by a surface 2, which can be a retail shelf. An EL panel covers the top of the surface 2, the support 3 for the surface 2 (e.g., the shelf) and the underside of the surface 4 above the product 1. From the perspective of the consumer, the product appears illuminated from below, behind and above when the EL panel is powered.

FIG. 6 shows an embodiment of a merchandise display system that includes a stepped support 6 which is or is a part of surface 2. The stepped support 6 can be, for example, a stiff paperboard support that is supported by or affixed to surface 2 such that a product 1 can be displayed at varying heights or distances with respect to surface 2. An EL panel 5 can conform, such as by bending, to the stepped support 6 and the product 1 can sit on top of the EL panel 5 for display. From the perspective of the consumer, the product appears illuminated from below, behind and above when the EL panel is powered.

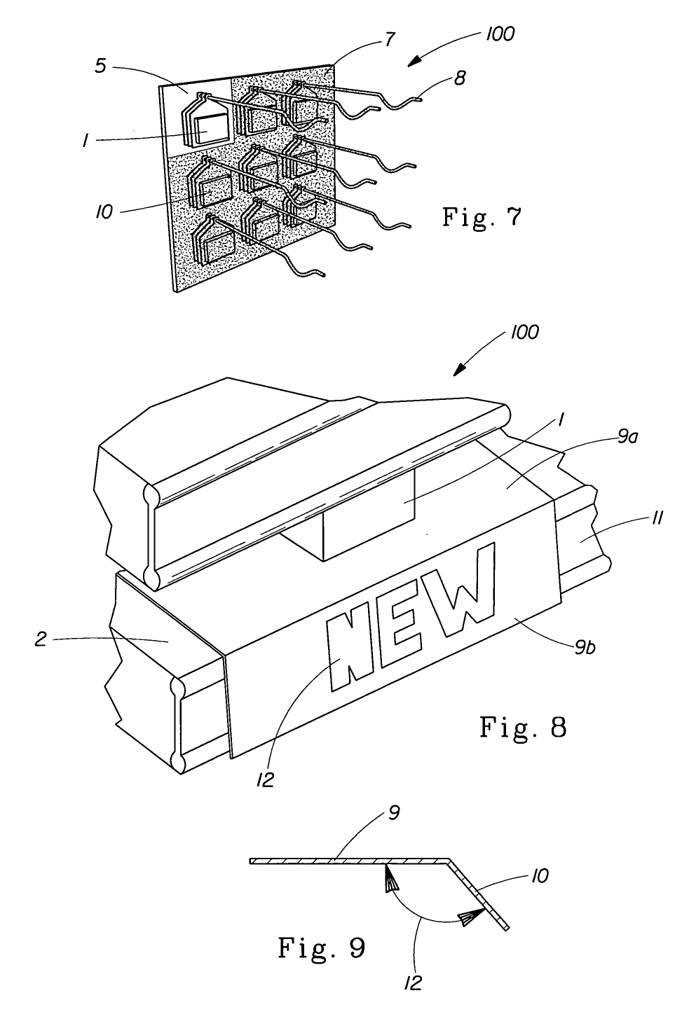

FIG. 7 shows an embodiment of a merchandise display system 100 in which products 1 are supported by pegs on a peg board 7 that includes an EL panel 5. The EL panel 5 can be hung or otherwise affixed to the pegboard 7 in a manner to permit pegs 8 to be attached by means known in the art. From the perspective of the viewer, products 1 can hang between the EL panel and the viewer. From the perspective of the consumer, the products between the EL panel and the viewer appear illuminated from behind, particularly when compared to adjacent non-illuminated products 10.

FIG. 8 shows an embodiment of a merchandise display system in which a product 1 is supported on a surface 2 that is a retail shelf covered by an EL panel having a first portion 9a and a second portion 9b which is disposed in an angular relation with the first portion such that it can cover a front portion of surface 2, such as the front of retail shelf display. In the embodiment shown, the front portion of surface 2 comprises a price channel 11. The second portion of the EL panel can further comprise indicia 12, such as promotional text, pricing information, or other product information.

FIG. 9 shows how the angular relation 12 between a first portion 9a of an EL panel and a second portion 9b of an EL panel is measured, and/or how the angular relation between a first EL panel 9a and a second EL panel 9b is measured. The angular relation 12 may be selected from the group consisting of: a zero angle; an acute angle; a right angle; an obtuse angle, a straight angle; a reflex angle; a full angle and combinations thereof. For example, a second portion (or panel) 9b may be disposed relative to a first portion (or panel) 9a in an angle from about 25 to about 180 degrees, from about 45 to about 135 degrees or from about 60 to about 105 degrees.

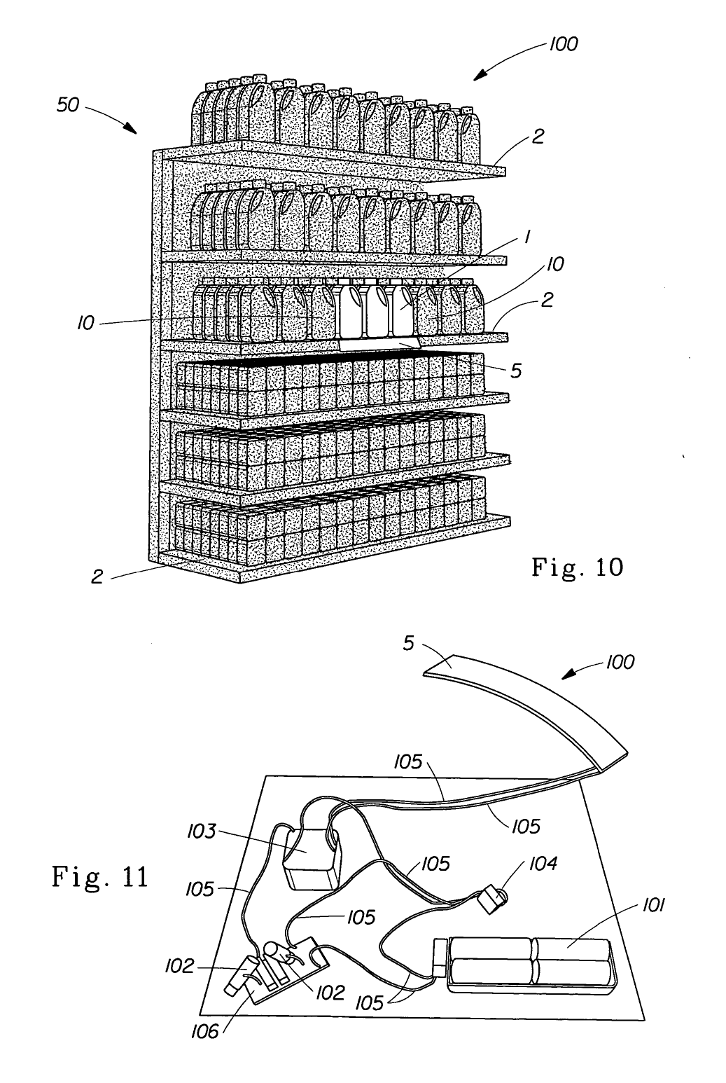

FIG. 10 shows another embodiment of a merchandise display system. FIG. 10 is a perspective view of a portion of a series of surfaces 2 that are shelves, also known as gondola shelving 50. As shown, one shelf partially covered by an EL panel 5. When powered, the EL panel 5 illuminates the products 1 resting on the EL panel 5. To the consumer, the illuminated products 1 appear brighter than the products 10 that are not sitting on top of the EL panel 5. Additionally, because the EL panel 5 is provided across a large surface area, close illumination of a large number of products 1 can thus be obtained. The EL panel 5 thus provides illumination from many points and across a large surface area to thereby provide direct and even lighting of the products.

FIG. 11 shows one embodiment of how the elements of a merchandise display system 100 can be operatively connected to one another. Additionally, this embodiment illustrates how elements may be combined such that the EL panel 5, which forms one element of the merchandise display system 100, is powered as a result of the detection of movement near the system (e.g., the approach of a consumer).

Three electrical circuits are formed. A first electrical circuit is made by operatively connecting the following elements together using electrical wiring 105. A portable voltage source 101, in this case comprising batteries, is connected to a power switch 104, which is in turn connected to a microcontroller 106 comprising motion sensors 102; the microcontroller 106 is connected back to the portable voltage source 101.

A second electrical circuit is made by operatively connecting the following elements together using electrical wiring 105. The portable voltage source 101 is connected to the power switch 104, which is in turn connected to a power inverter 103, which is connected to the microcontroller 106 comprising motion sensors 102; the microcontroller 106 is connected back to the portable voltage source 101.

A third electrical circuit is made by operatively connecting the power inverter 103 to an EL panel 5 using electrical wiring.

When the power switch 104 is in the “on” position, electrical current flows through the first circuit such that the microcontroller 106 and motion sensors 102 are powered. Upon detection of motion, the microcontroller 106 closes the second circuit, thereby supplying electrical current to the power inverter 103. The power inverter 103 then provides the EL panel 5 with electrical current at the proper voltage via the third circuit. The powered EL panel 5 emits light.

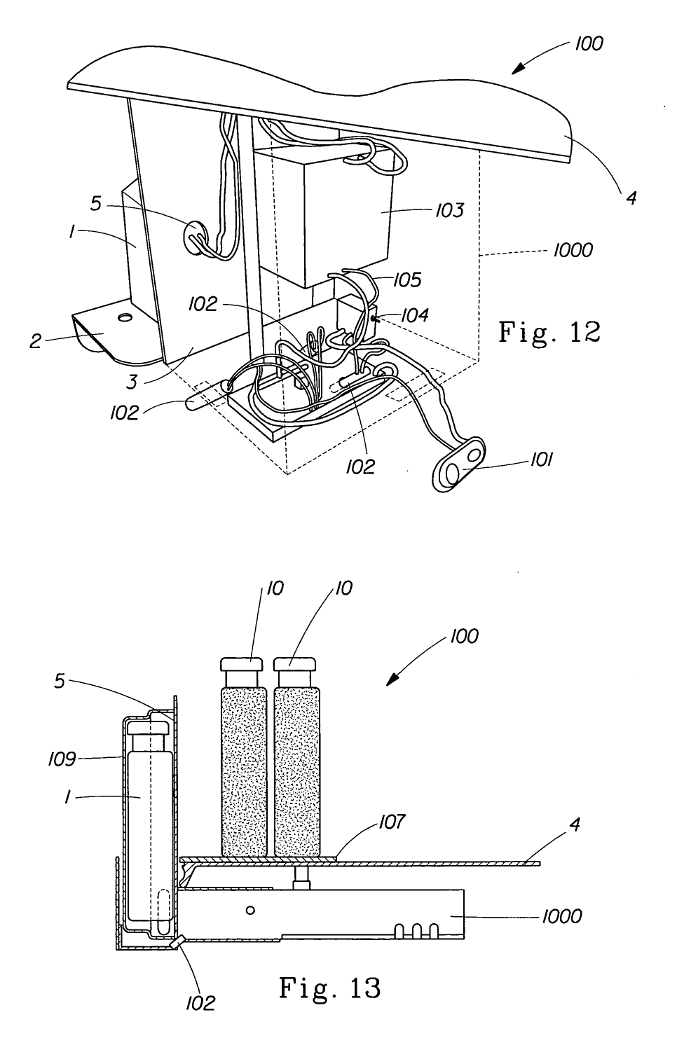

FIG. 12 shows an embodiment of a small, portable merchandise display system 100 that may be attached to a retail display, in this case a shelf 4. The merchandise display system 100 comprises elements operatively connected together as described in the prior embodiment. However, in this embodiment, most of the elements are located in a housing unit 1000 (depicted in phantom for clarity) that is located behind the merchandise 1 to be illuminated. The merchandise display system 100 is attached to the shelf 4 such that it hangs below the shelf.

A product is supported by a surface 2 which is in turn supported by a back wall 3. An EL panel 5 covers the back wall 3 and wiring 105 runs from the EL panel through the back wall to the power inverter 103, which is located in the housing unit 1000 along with all of the other elements except the motion sensors 102 and the power source 101. The motion sensors 102 partially extend out of holes in the housing unit 1000 at an angle that provides for detection of a consumer approaching the display. The power source 101 (in this case just the battery leads are shown and not the batteries) is arranged to extend from a hole in the back of the housing unit 1000 so that batteries may be easily attached thereto.

This embodiment provides several advantages. First, when the merchandise display system 100 is connected to the shelf 4, the consumer sees the product 1 and the EL panel 5 when viewing the system from the front. The consumer does not see all of the elements that are hidden from view in the housing unit 1000 located behind the back wall 3. Second, the merchandise display system 100 does not take up retail display space as it hangs below the shelf 4 on which merchandise is to be displayed for sale. Third, the batteries powering the merchandise display system may be easily installed and replaced.

FIG. 13 shows another embodiment of a small, portable merchandise display system 100 that may be attached to a retail display, in this case also a shelf 4. As in the previous embodiment, some of the elements of the merchandise display system are hidden in a housing unit 1000. A product 1 is housed in a plastic sleeve 109 that is attached to a back wall 3 that is connected to a retail shelf 4 using a clamp 107. An EL panel 5 covers the back wall 3 and wiring 105 runs from the EL panel through the back wall to the power inverter 103, which is located in the housing unit 1000 along with all of the other elements except the motion sensors 102. The motion sensors 102 partially extend out of holes in the housing unit 1000 at an angle that provides for detection of a consumer approaching the display.

This embodiment has the advantages of the previous embodiment. Additionally, this embodiment takes up less space under the shelf to which it is attached. This may be advantageous if there is a shelf or other display space located below the shelf to which the system is attached.

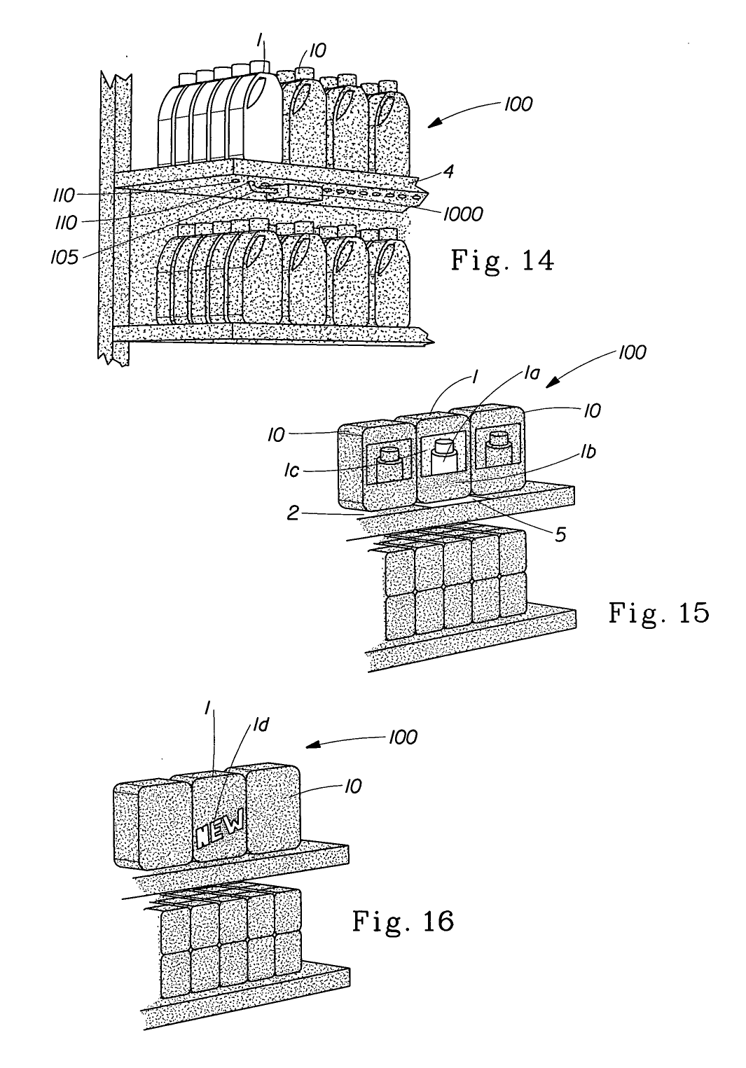

FIG. 14 shows another embodiment of a small, portable merchandise display system 100 that may be attached to a retail display, in this case also a shelf 4. As in the previous embodiment, some of the elements of the merchandise display system 100 are hidden in a housing unit 1000. In this embodiment, the products 1 sit upon an EL panel (not shown) which in turn is located on top of a shelf 4. The wiring 105 that connects the EL panel to the rest of the elements runs through a hole in the shelf 110 and into the housing unit 1000.

FIG. 15 is a perspective view of an embodiment of a merchandise display system 100 in which an EL panel 5 is configured to illuminate a portion of a product 1 comprising packaging. A product 1 is shown that comprises a primary package 1a, i.e., a bottle, which is in turn contained within a secondary package 1b. The secondary package 1b is a box with a transparent bottom (not shown in this perspective) and transparent window 1c through which the bottle 1a may be seen when the box is placed upright on a surface 2 such as a retail shelf. When the product 1 is displayed, light from a powered electroluminescent panel 5 is transmitted through the transparent bottom of the secondary package to the primary package 1a. When viewed by the consumer through the transparent window 1c, the primary package 1a, i.e. the bottle, is illuminated.

FIG. 16 is a perspective view of another embodiment of a merchandise display system 100 in which an EL panel is configured to illuminate a portion of a product. A product 1 comprising a package, i.e. a box, is sitting among other products 10 on a retail shelf. An EL panel is cut such that it takes the shape of indicia 1d, in this case the letters “NEW”. The EL panel in the shape of indicia 1d is attached to outside of the box 1, and wires (not shown in this view) run through the box and connect the EL panel in the shape of indicia 1d to a power source that is hidden from view. When the EL panel is powered, the indicia 1d are illuminated.

In another embodiment, the merchandise display system is linked to a triggering device that is configured with motion sensors that detect the motion of approaching consumer(s) from multiple directions. Upon sensing an approach, the triggering device sends a signal to the merchandise display system to perform an action. This embodiment is accomplished by installing one or more motion sensors capable of sensing movement at angles ranging inclusively from about 5 to about 170 degrees, from about 20 to about 150 degrees, and from about 45 to about 135 degrees relative to the front of the merchandise display system to be triggered.

In another embodiment, a pair of infrared sensors having line-of-sight activation disposition are oriented in directions opposite to each other in order to capture the approach of consumers from either direction in an aisle. To prevent multiple actions by the merchandise display system in response to the approach of multiple consumers within a small time frame, the merchandise display system has a time out feature that ignores signals from the triggering device until the system runs through at least one cycle of action.

To ensure that the merchandise display system performs an action when a consumer is close to the system, some embodiments comprise motion sensors that are arranged to detect the motion of the consumer within a given angle of approach in respect to the system. Angles of approach may range inclusively from about 35 to about 145 degrees, from about 45 to about 135 degrees, or from about 55 to about 125 degrees.

In another embodiment, the merchandise display system is configured such that a triggering device comprises two or more light sensors that are articulated to point at different angles, one pointing downward and one pointing relatively higher. If the lower sensor detects a change in light, the presence of a child is indicated. If both of the sensors detect a change in light, the presence of an adult is indicated. A signal is then sent to the merchandise display system indicating that the system should show a display that is specific to a child or to an adult.

In another embodiment, a merchandise display system is activated when a consumer swipes a magnetic card that contains information about the consumer's identity through a card reader that is part of a triggering device. Based upon the information on the card, the triggering device signals the merchandise display system to act by showing a display that is customized to the identified consumer.

In another embodiment, an RFID tag is placed upon the key ring of a consumer. A merchandise display system has a trigger that comprises an RFID reader. When the consumer walks into range of the reader, the trigger senses the signal from the tag and indicates to the merchandise display system to act by showing a display that is customized to the identified consumer.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention. Moreover, although multiple inventive aspects have been presented, such aspects need not be utilized in combination, and various combinations of inventive aspects are possible in light of the various embodiments provided above.

What is claimed is:

1. A merchandise display system, said system comprising:
a. merchandise;
b. a surface; and
c. an electroluminescent panel comprising at least a first portion,
wherein said first portion is disposed between said surface and said merchandise, and illuminates said merchandise when powered.

2. The merchandise display system according to claim 1, wherein said surface is oriented to support said merchandise.

3. The merchandise display system according to claim 2, wherein said electroluminescent panel is integral with at least a portion of said surface.

4. The merchandise display system according to claim 2, wherein said surface is selected from the group consisting of: shelves; countertops; floors; walls; ceilings; pegboards; and combinations thereof.

5. The merchandise display system according to claim 1, wherein said electroluminescent panel further comprises indicia.

6. The merchandise display system according to claim 1, wherein said electroluminescent panel comprises shapes selected from the group consisting of: generally flat; curvilinear; and combinations thereof.

7. The merchandise display system according to claim 1, further comprising
a portable voltage source configured to power said electroluminescent panel.

8. The merchandise display system according to claim 1, further comprising a triggering device.

9. The merchandise display system according to claim 8, wherein said triggering device signals said merchandise display system to provide a consumer specific display.

10. The merchandise display system according to claim 1, further comprising a safety system.

11. The merchandise display system according to claim 1, wherein said electroluminescent panel further comprises at least one additional portion disposed in an angular relation relative to said first portion, wherein said angular relation relative to said first portion is selected from the group consisting of: a zero angle; an acute angle; a right angle; an obtuse angle, a straight angle; a reflex angle; a full angle; and combinations thereof.

12. The merchandise display system according to claim 11, wherein said additional portion further comprises indicia.

13. A merchandise display system in proximity to a retail display, wherein said merchandise display system comprises:
a. merchandise;
b. a surface oriented to support said merchandise; and
c. an electroluminescent panel attached to said surface;
wherein said electroluminescent panel illuminates said merchandise when said electroluminescent panel is powered.

14. The merchandise display system according to claim 13, wherein said retail display is selected from the group consisting of: shelves; gondola shelving; countertops; pegboards; doors; and combinations thereof.

15. The merchandise display system according to claim 14, wherein said merchandise display system is attached to said retail display.

16. The merchandise display system according to claim 14, wherein said retail display is an end-of-aisle display.

17. The merchandise display system according to claim 13, further comprising
a portable voltage source configured to power said electroluminescent panel.

18. The merchandise display system according to claim 13, further comprising a triggering device.

19. The merchandise display system according to claim 18, wherein said triggering device signals said merchandise display system to provide a consumer specific display.

20. The merchandise display system according to claim 13, further comprising a safety system.

21. A merchandise display system comprising:
a. a package; and
b. an electroluminescent panel;
wherein said electroluminescent panel is connected to at least one portion of said package.

22. The merchandise display system according to claim 21, wherein said electroluminescent panel illuminates at least a portion of said package when said system is powered.

23. The merchandise display system according to claim 21, wherein said electroluminescent panel is in the form of indicia.
